(19) United States
(12) Patent Application Publication
(10) Pub. No.: US 2017/0105012 A1
(43) Pub. Date: Apr. 13, 2017

(54) Method and Apparatus for Cross Color Space Mode Decision

(71) Applicant: MEDIATEK INC., Hsin-Chu (TW)

(72) Inventors: Tung-Hsing Wu, Chiayi City (TW); Li-Heng Chen, Tainan City (TW); Han-Liang Chou, Hsinchu County (TW)

(21) Appl. No.: 15/221,606

(22) Filed: Jul. 28, 2016

Related U.S. Application Data
(60) Provisional application No. 62/238,855, filed on Oct. 8, 2015.

(51) Int. Cl. H04N 19/186; H04N 19/103; H04N 19/154; H04N 19/176

(52) U.S. Cl. CPC H04N 19/186; H04N 19/176; H04N 19/103; H04N 19/154

(57) ABSTRACT

A method and apparatus of encoding using multiple coding modes with multiple color spaces are disclosed. Weighted distortion is calculated for each candidate mode and a target mode is selected according to information including the weighted distortion. Each candidate coding mode is selected from a coding mode group including at least a first coding mode and a second coding mode, where the first coding mode uses a first color space for encoding one block and the second coding mode uses a second color space for encoding one block, and the first color space is different from the second color space. The weighted distortion corresponds to a weighted sum of distortions of color channels for each color transformed current block using a set of weighting factors and the set of weighting factors is derived based on a color transform associated with a corresponding color space for each coding mode.

### CROSS REFERENCE TO RELATED APPLICATIONS

The present invention claims priority to U.S. Provisional Patent Application, Ser. No. 62/238,855, filed on Oct. 8, 2015. The U.S. Provisional Patent Application is hereby incorporated by reference in its entirety.

### BACKGROUND

Field of the Invention

The present invention relates to coding mode selection for a video coding system. In particular, the present invention relates to method and apparatus to select a best coding mode from multiple coding modes, where at least two coding modes use different color formats.

Background and Related Art

Video data requires a lot of storage space to store or a wide bandwidth to transmit. Along with the growing high resolution and higher frame rates, the storage or transmission bandwidth requirements would be formidable if the video data is stored or transmitted in an uncompressed form. Therefore, video data is often stored or transmitted in a compressed format using video coding techniques. The coding efficiency has been substantially improved using newer video compression formats such as H.264/AVC, VP8, VP9 and the emerging HEVC (High Efficiency Video Coding) standard. In order to maintain manageable complexity, an image is often divided into blocks, such as macroblock (MB) or coding unit (CU) to apply video coding. Video coding standards usually adopt adaptive Inter/Intra prediction on a block basis.

FIG. 1 illustrates an exemplary adaptive Inter/Intra video coding system incorporating loop processing. For Inter-prediction, Motion Estimation (ME)/Motion Compensation (MC) 112 is used to provide prediction data based on video data from other picture or pictures. Switch 114 selects Intra Prediction 110 or Inter-prediction data and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. When an Inter-prediction mode is used, a reference picture or pictures have to be reconstructed at the encoder end and will be used as reference data for one or more other pictures. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer (RPB) 134 and used for prediction of other frames.

In FIG. 1, the input video data is often converted to a color format that is suited for efficient video coding. For example, YUV or YCbCr color format is widely used in various video coding standards since the representation in the luminance (i.e., Y) and chrominance (i.e., UV or CbCr) components can reduce correlation among in original color format (e.g. RGB). Furthermore, each color format may support various sampling patterns, such as YUV444, YUV422 and YUV420.

The YUV or YCrCb color format uses real valued color transform matrix. The color transform-inverse color transform pair often introduces minor errors due to limited numerical accuracy. Recent development in the field of video processing introduces a reversible color transformation, where coefficients of the color transform and the inverse color transform can be implemented using a small number of bits. For example, the YCoCg color format can be converted from the RGB color format using color transform coefficients represented by 0, 1, ½, and ¼. While transformed color format such as YCoCg is suited for images from nature scenes, the transformed color format may not be always the best format for other types of image contents. For example, the RGB format may result in lower cross-color correlation for artificial images than images corresponding to a natural scene. Accordingly, for state-of-the-art image and video coding, multiple coding modes can be applied for coding a block of pixels and coding modes are allowed to use different color formats. These state-of-the-art image and video coding standards include, but not limited to, Display Stream Compression (DSC) and Advanced Display Stream Compression (A-DSC) standardized by a Video Electronics Standards Association (VESA).

During encoding, the encoder has to make mode decision among multiple possible coding modes for each given coding block such as a macroblock or a coding unit. In mode decision, one or more selection criteria, also referred as cost, associated with different coding modes are derived for comparison so that a best mode achieving the lowest cost is selected for encoding a block of pixels. Various costs have been used as the criterion for the best mode selection. For example, the cost may correspond to distortion only. In this case, the mode that achieves the lowest cost is selected as the best mode regardless of the required bitrate. In many practical systems, there is often a constraint on the available bitrate budget. Accordingly, a cost function that also involves the bitrate has been widely used. The cost function is represented as:

cost=distortion+λ·rate, (1)

where λ is the weighted factor for distortion and rate, and distortion means a difference measure between the source pixels and the decoded (or processed) pixels induced by one or more lossy processing during the compression process, such as quantization and frequency transform. There are several commonly used distortion measures. For example, the distortion can be computed between the source pixels and the decoded pixels. Distortion can be measured in terms of SAD (sum of absolute difference), SSE (sum of square error), etc.

On the other hand, the rate in eq. (1) can be measured as the number of bits required for coding a block of pixels with a specific coding mode. The rate can be the actual bit count for coding a block of pixels. The rate can also be an estimated bit count for coding a block.

When the coding modes involve more than one color space, the mode decision among different coding modes in different color spaces becomes an issue. Since the distortion measure in different color spaces may not have the same quantitative meaning, the distortion measures in different color spaces cannot be compared directly.

FIG. 2 illustrates an example of a coding system having four possible coding modes, where a current block of pixels (210) may select a coding mode from the group of coding modes A, B, C and D (221, 222, 223 and 224). The possible coding modes are also called candidate coding modes in this disclosure. Coding modes A and B use RGB color space and modes C and D use YCoCg color space. The mode decision unit 230 selects a best coding mode from the four possible coding modes and applies the chosen coding mode to the current block as shown in step 240. In this case, the rate rateᵢ and distortion distortionᵢ are computed for each coding mode i, where i=A, B, C or D. Distortion distortionᵢ is calculated in the RGB color space for i=A and B, and distortion distortionᵢ is calculated in the YCoCg color space for i=C and D. Since the distortion in two different color spaces (i.e., RGB and YCoCg) corresponds to different quantitative measures, the distortion in two different color spaces needs to be processed before the distortion in two different color spaces can be compared meaningfully.

Therefore, it is desirable to develop techniques for comparing the distortions derived from different color spaces.

### SUMMARY

A method and apparatus of encoding using multiple coding modes with multiple color spaces are disclosed. Weighted distortion is calculated for each candidate mode and a target mode is selected according to information including the weighted distortion. Each candidate coding mode is selected from a coding mode group comprising at least a first coding mode and a second coding mode, where the first coding mode uses a first color space for encoding one block and the second coding mode uses a second color space for encoding one block, and the first color space is different from the second color space. The weighted distortion corresponds to a weighted sum of distortions of color channels for each color transformed current block using a set of weighting factors and the set of weighting factors is derived based on a color transform associated with a corresponding color space for each coding mode. The selected coding mode is then applied to encode the current block.

If one of the first color space and the second color space corresponds to YCoCg color space, the distortions of color channels are designated as Distortion_{Y}, Distortion_{Co}, and Distortion_{Cg} for Y, Co and Cg channels respectively, and the set of weighting factors are designated as W_{Y}, W_{Co}, and W_{Cg}, then the weighted sum of distortions of color channels is derived according to:

Distortion_{YCoCg}=Distortion_{Y}×W_{Y}+Distortion_{Co}×W_{Co}+Distortion_{Cg}×W_{Cg},

where W_{Y}, W_{Co}, and W_{Cg} are derived based on the color transform associated with the YCoCg color space. In one example, W_{Y}, W_{Co}, and W_{Cg} are set to be proportion to the norms (i.e., W_{Y}:W_{Co}:W_{Cg}=3:0.5:0.75) based on distortion using a second-order function. In another example, W_{Y}, W_{Co}, and W_{Cg} are set to be the proportional to the square root of the norms (i.e., W_{Y}:W_{Co}:W_{Cg}=\sqrt{3}:\sqrt{0.5}:\sqrt{0.75}) based on distortion using a first-order function.

In another embodiment, the color channels of color transformed input pixels in a corresponding color space are quantized using different quantization bit-depths and the set of weighting factors are further related to the different quantization bit-depths. For example, if YCoCg color space is used and the quantization bit-depth for Co and Cg color channels is one bit less than Y color channel, W_{Y}, W_{Co}, and W_{Cg} are set to be the proportional to the norms (i.e., W_{Y}:W_{Co}:W_{Cg}=3:2:3) based on distortion using a second-order function in one example. In another example, W_{Y}, W_{Co}, and W_{Cg} are set with the proportional to the square root of the norms (i.e., W_{Y}:W_{Co}:W_{Cg}=\sqrt{3}:\sqrt{2}:\sqrt{3} based on distortion using a first-order function.

According to another method, the issue of distortions in different color spaces is solved by applying an inverse color transform to the distortions of color channels to generate color transformed distortion. The inverse color transform corresponds to the color transform associated with each candidate coding mode. A target coding mode is selected from the coding mode group based on cost measures, wherein the cost measures include the color transformed distortions for the candidate coding modes. The target coding mode may correspond to a mode that achieves the least cost measure.

According to a third method for solving the issue of distortions in different color spaces, common color space transform is used to convert pixel data in a corresponding color space associated with each candidate coding mode to a common color space. The common color space transform is applied to source data and processed data and the unified distortion is measured between the source data and the processed data after the common color space transform. A target coding mode is selected from the candidate coding modes based on cost measures of the candidate coding modes, where cost measures include the unified distortions for the current block using the candidate coding modes. The target coding mode may correspond to a mode that achieves the least cost measure.

The encoding process may comprise a prediction stage, followed by a quantization stage, followed by an inverse quantization stage, and followed by a reconstruction stage. The source data may correspond to input data to the quantization stage and the processed data may correspond to output data from the inverse quantization stage. In another embodiment, the source data may correspond to input data to the prediction stage and the processed data may correspond to output data from the reconstruction stage. The encoding process may further comprises a transform stage and an inverse transform stage, where the transform stage is located between the prediction stage and the quantization stage, and the inverse transform stage is located between the inverse quantization stage and the reconstruction stage. In this case, the source data may correspond to input data to the transform stage and the processed data may correspond to output data from the inverse transform stage. If the YCoCg color space is used by a candidate coding mode and the common color space corresponds to RGB color space, then the unified distortion is measured by applying YCoCg-to-RGB color transform to the source data and the processed data.

### BRIEF DESCRIPTION OF THE DRAWINGS

FIG. 1 illustrates an exemplary adaptive Inter/Intra video coding system incorporating transform/inverse transform and quantization/inverse quantization.

FIG. 2 illustrates an example of a coding system having four possible coding modes, where a current block of pixels may select a coding mode from the group of coding modes (A, B, C and D).

FIG. 3 illustrates an example of a coding system that includes a candidate coding mode using the YCoCg color space, where the coding process includes prediction/reconstruction and quantization/inverse quantization.

FIG. 4 illustrates an example of a coding system that includes a candidate coding mode using the YCoCg color space, where the coding process includes prediction/reconstruction, transform/inverse transform and quantization/inverse quantization.

FIG. 5 illustrates an exemplary flowchart of an encoder of video/image compression using multiple coding modes with multiple color spaces, where weighted distortion is used according to an embodiment of the present invention.

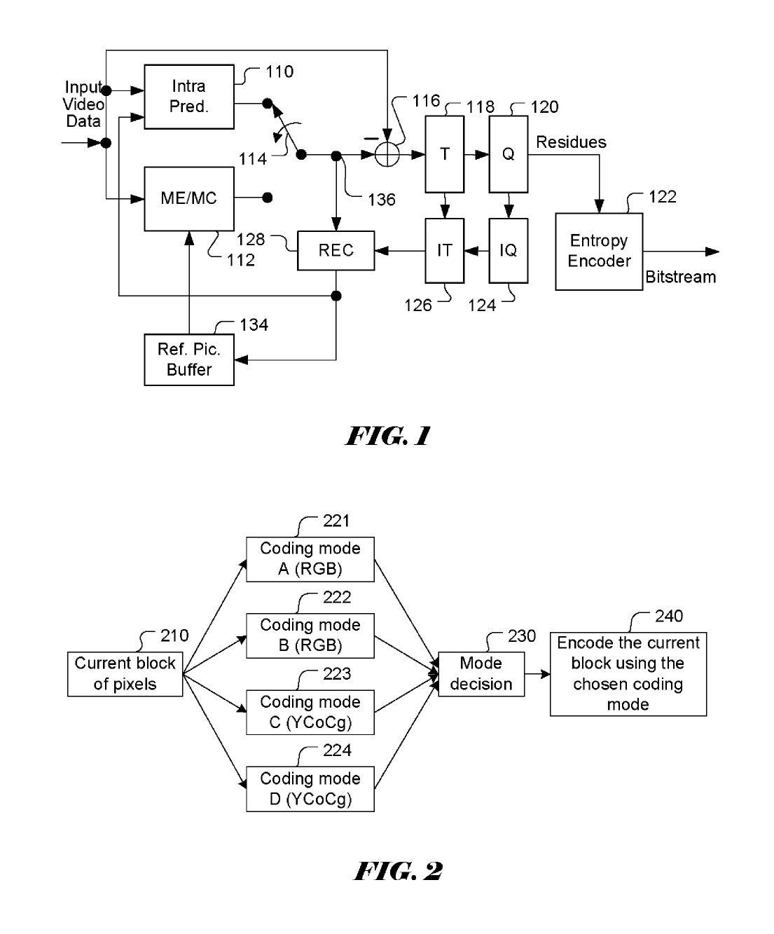

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

### First Method

As mentioned before, the distortion indifferent color spaces (e.g. RGB and YCoCg) corresponds to different quantitative measures, the distortion in two different color spaces needs to be processed before the distortion in two different color spaces can be compared meaningfully. Accordingly, a first method of the present invention uses weighted distortion of a color space as one of basis for selecting a target coding mode, where a set of weighting factors are derived according to the color transform associated with the candidate coding mode. For example, there are two color spaces are used. A first coding mode encodes video data in the first color space and a second coding mode encodes video data in the second color space, where the first color space is different from the second color space. The distortion associated with each coding mode is derived as a weighted sum of distortions of color channels using a set of weighting factors related to the underlying color transform associated with the color space for this coding mode. The color channels refer to the color components of a corresponding color space. In the mode decision process, the weighted distortion associated with each coding mode is included in the cost measurement for selecting a target mode. The target mode selected is then applied to encode a current block. The target coding mode may correspond to a mode that achieves the least cost measure.

If a coding mode uses the YCoCg color space and the weighting factors for the YCoCg color space are W_{Y}, W_{Co} and W_{Cg} respectively, the weighted distortion for the YCoCg color space is derived according to:

Distortion_{YCoCg}=Distortion_{Y}×W_{Y}+Distortion_{Co}×W_{Co}+Distortion_{Cg}×W_{Cg} (2)

If a coding mode uses the RGB color space and the weighting factors for the RGB color space are W_{R}, W_{G} and W_{B} respectively, the weighted distortion for the RGB space is derived according to:

Distortion_{RGB}=Distortion_{R}×W_{R}+Distortion_{G}×W_{G}+Distortion_{B}×W_{B} (3)

In one example, weighting factors (W_{R}, W_{G}, W_{B}) can be set to (1, 1, 1).

The color transform matrix from the RGB color space to the YCoCg color space can be represented by:

$$[ \begin{matrix}Y \\ Co \\ Cg\end{matrix} ] = [ \begin{matrix}1 / 4 & 1 / 2 & 1 / 4 \\ 1 & 0 & - 1 \\ - 1 / 2 & 1 & - 1 / 2\end{matrix} ] [ \begin{matrix}R \\ G \\ B\end{matrix} ] \qquad ( 4 )$$

If a coding mode uses the YCoCg color space and the associated quantization process quantizes the Co and Cg color channels (i.e., Co and Cg color components) using one bit less than the Y color channel (i.e., Y color component), the combined color transform matrix including the quantization effect can be represented as:

$$[ \begin{matrix}Y \\ Co \\ Cg\end{matrix} ] = [ \begin{matrix}1 / 4 & 1 / 2 & 1 / 4 \\ 1 / 2 & 0 & - 1 / 2 \\ - 1 / 4 & 1 / 2 & - 1 / 4\end{matrix} ] [ \begin{matrix}R \\ G \\ B\end{matrix} ] \qquad ( 5 )$$

As shown in eq. (5), the difference in quantization bit-depth is reflected in the quantization matrix by dividing the transform matrix entries related to Co and Cg by 2. Accordingly, the second row and the third row of the transform matrix entries become half compared to the transform matric in eq. (4). The inverse color transform corresponding to eq. (5) can be represented as:

$$[ \begin{matrix}R \\ G \\ B\end{matrix} ] = [ \begin{matrix}1 & 1 & - 1 \\ 1 & 0 & 1 \\ 1 & - 1 & - 1\end{matrix} ] [ \begin{matrix}Y \\ Co \\ Cg\end{matrix} ] \qquad ( 6 )$$

The suitable weighting factors for weighted distortion can be derived according to the norm value of the matrix in eq. (6). The norm values for (Y, Co, Cg) can be determined as:

(Y,Co,Cg)=(1²+1²+(1)²,1²+0²+(−1)²,(−1)²+1²+(−1)²)=(3,2,3) (7)

For distortion using a second order function, such as sum of square error, the weighting factors are derived as:

W_{Y}:W_{Co}:W_{Cg}=3:2:3. (8)

For distortion using a first order function, such as sum of absolute difference, the weighting factors are derived as:

W_{Y}:W_{Co}:W_{Cg}=\sqrt{3}:\sqrt{2}:\sqrt{3}. (9)

In another embodiment, the quantization process is taken into account for the weighting factor derivation. The color transform matrix from the RGB color space to the YCoCg color space is represented as:

$$[ \begin{matrix}Y \\ Co \\ Cg\end{matrix} ] = [ \begin{matrix}1 / 4 & 1 / 2 & 1 / 4 \\ 1 & 0 & - 1 \\ - 1 / 2 & 1 & - 1 / 2\end{matrix} ] [ \begin{matrix}R \\ G \\ B\end{matrix} ] \qquad ( 10 )$$

According to eq. (10), the inverse color transform becomes:

$$[ \begin{matrix}R \\ G \\ B\end{matrix} ] = [ \begin{matrix}1 & 1 / 2 & - 1 / 2 \\ 1 & 0 & 1 / 2 \\ 1 & - 1 / 2 & - 1 / 2\end{matrix} ] [ \begin{matrix}Y \\ Co \\ Cg\end{matrix} ] \qquad ( 11 )$$

The suitable weighting factors for weighted distortion can be derived according to the norm value of the matrix in eq. (6). The norm values for (Y, Co, Cg) can be determined as:

(Y,Co,Cg)=(1²+1²+1²,(½)²+0²+(−½)²,(−½)²+(½)²+(−½)²)=(3,0.5,0.75) (12)

For distortion using a second order function, such as sum of square error, the weighting factors are derived as:

W_{Y}:W_{Co}:W_{Cg}=3:0.5:0.75. (13)

For distortion using a first order function, such as sum of absolute difference, the weighting factors are derived as:

W_{Y}:W_{Co}:W_{Cg}=\sqrt{3}:\sqrt{0.5}:\sqrt{0.75}. (14)

### Second Method

In order to address the issue of distortion in different color spaces, a second method of the present invention applies color transform on the distortions of color channels associated with the coding mode. For example, two color spaces are used. A first coding mode encodes video data in the YCoCg color space and a second coding mode encodes video data in the RGB color space. The distortions associated with the Y, Co, and Cg color channels are Distortion_{Y}, Distortion_{Co}, and Distortion_{Cg} respectively. The distortions associated with the Y, Co, and Cg color channels are transformed to the RGB color space according to the color transform matrix in eq. (6) to obtain Distortion_{R}, Distortion_{G}, and Distortion_{B}. The color transformed distortions in the RGB color space can be determined as:

$$[ \begin{matrix}{Distortion}_{R} \\ {Distortion}_{G} \\ {Distortion}_{B}\end{matrix} ] = [ \begin{matrix}1 & 1 & - 1 \\ 1 & 0 & 1 \\ 1 & - 1 & - 1\end{matrix} ] [ \begin{matrix}{Distortion}_{Y} \\ {Distortion}_{Co} \\ {Distortion}_{Cg}\end{matrix} ] \qquad ( 15 )$$

The weighted distortion in the RGB color space can be derived as:

Distortion_{RGB}=Distortion_{R}×W_{R}+Distortion_{G}×W_{G}+Distortion_{B}×W_{B} (16)

where W_{R}, W_{G} and W_{B} are weighting factors for the RGB color space.

### Third Method

In order to address the issue of distortion in different color spaces, a third method of the present invention measures the distortion in a common color space domain regardless of whatever color space is used for a coding mode. For example, a first coding mode may be using a first color space and a second coding mode may be using a second color space, where the first color space is different from the second color space. In order to evaluate the distortion based on a common color space, the distortion associated with the first coding mode is measured by converting both the source video data and processed video data into the third color space (i.e., the common color space). Similarly, the distortion associated with the second coding mode is measured by converting both the source video data and processed video data into the third color space (i.e., the common color space). The processed video data may correspond to fully reconstructed video data or intermediately reconstructed data.

FIG. 3 illustrates an example of a coding system that includes a candidate coding mode using the YCoCg color space. The original input pixels 310 are in the RGB color space, where the input pixels may correspond to video data or image data to be processed. However, according to the candidate coding mode, the input pixels are processed in the YCoCg color space. Accordingly, a color transform is applied to the input pixels to convert them into the YCoCg space as shown in step 320. The pixels in the YCoCg color space are predicted by prediction of input pixels 360. The prediction residual (i.e., signal output from subtractor 362) is quantized by quantization unit 330 and the quantized output is coded using entropy coding 340 for compressed bitstream. Since reconstructed pixels may be needed for prediction of other pixels, reconstructed pixels may need to be generated in the encoder side. Accordingly, the prediction residual is reconstructed using inverse quantization 350. The reconstructed prediction residual is added to the prediction of input pixels 360 using adder 364 to form reconstructed pixels 370. In FIG. 3, the color space associated with the selected coding mode may correspond to another color space (e.g. RGB or other color space).

When different color spaces are by different coding modes in the coding process, the distortion measures may correspond to different quantitative scale, which causes difficulty in assessing distortions associated with different coding modes. According to the third method, the distortion is measured in a common color space. For example, the common color space may be the RGB color space. Therefore, if the selected coding mode uses the YCoCg color space for the coding process as shown in FIG. 3, the source data and the processed data associated with the coding mode will be color transformed into the common color space for distortion evaluation. In FIG. 3, input pixels 320 in the YCoCg color space are considered as the source data and the reconstructed pixels 370 (also in the YCoCg color space) are considered as the processed data. Accordingly, YCoCg-to-RGB color transform is applied to the input pixels 320 (i.e., source data) and the reconstructed pixels 370 (i.e., processed data). The distortion associated with the selected coding mode is then measured between the YCoCg-to-RGB color transformed input pixels 320 and the YCoCg-to-RGB color transformed reconstructed pixels 370.

The video signal in any intermediate stage can also be used for evaluating the distortion. For the system in FIG. 3, the quantization unit 330 will introduce error (i.e., distortion). Accordingly, corresponding intermediate signals before and after the quantization process (i.e., quantization 330/inverse quantization 350) can be used for distortion measure. For example, the input signal to the quantization unit 330 can be considered as the source data and the output from the inverse quantization unit 350 can be considered as the processed data. Therefore, the YCoCg-to-RGB color transform is applied to the input signal of the quantization unit 330 and the output of the inverse quantization unit 350 respectively. The distortion is measured between the color transformed input signal of the quantization unit 330 and the color transformed output of the inverse quantization unit 350.

If the color space associated with a coding mode is the same as the common color space, the color transform to convert the video data in the color space associated with a coding mode to the common color space corresponds to the identity matrix.

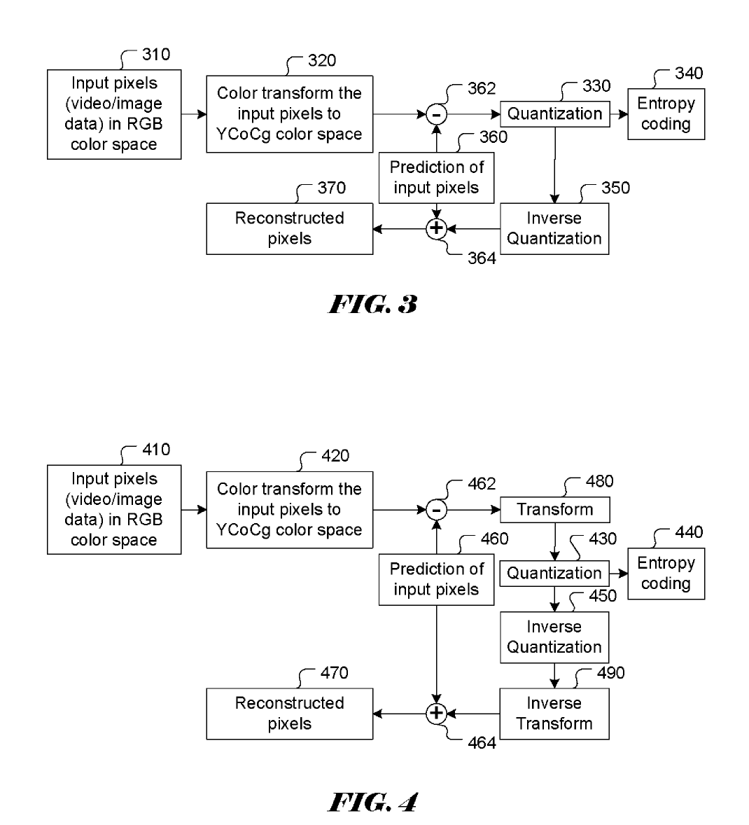

FIG. 4 illustrates another example of a coding system that includes a candidate coding mode using the YCoCg color space. The original input pixels 410 are in the RGB color space, where the input pixels may correspond to video data or image data to be processed. However, according to the candidate coding mode, the input pixels are processed in the YCoCg color space. Accordingly, a color transform is applied to the input pixels to convert them into the YCoCg space as shown in step 420. The input pixels in the YCoCg color space are predicted by prediction of input pixels 460. The prediction residual (i.e., signal output from subtractor 462) is processed by transform unit 480 and quantized by quantization unit 430 and the quantized output is coded using entropy coding 440 for compressed bitstream. Since the reconstructed pixels may be needed for prediction of other pixels, reconstructed pixels may need to be generated in the encoder side. Accordingly, the prediction residual is reconstructed using inverse quantization 450 and inverse transform 490. The reconstructed prediction residual is added to the prediction of input pixels 460 using adder 464 to form reconstructed pixels 470. In FIG. 4, the color space associated with the coding mode may correspond to another color space (e.g. RGB or other color space).

Again, the common color space is assumed to be the RGB color space. Therefore, if the selected coding mode uses the YCoCg color space for coding process as shown in FIG. 4, the source data and the processed data associated with the coding mode will be color transformed into the common color space for distortion evaluation. In FIG. 4, input pixels 420 in the YCoCg color space are considered as the source data and the reconstructed pixels 470 (also in the YCoCg color space) are considered as the processed data. Accordingly, YCoCg-to-RGB color transform is applied to the input pixels 420 and the reconstructed pixels 470. The distortion associated with the selected coding mode is then measured between the YCoCg-to-RGB color transformed input pixels 420 and the YCoCg-to-RGB color transformed reconstructed pixels 470.

Similarly, the distortion can be measured by applying the YCoCg-to-RGB color transform to the input signal to the quantization unit 430 and the output from the inverse quantization unit 450. Furthermore, the distortion can also be measured by applying the YCoCg-to-RGB color transform to the input of transform 480 and the output of inverse transform 490 respectively.

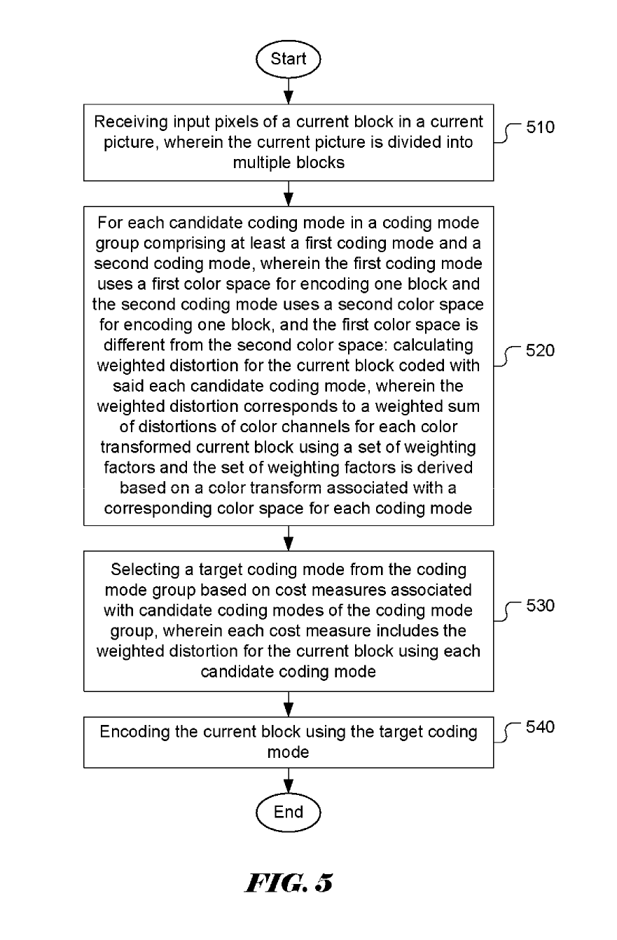

FIG. 5 illustrates an exemplary flowchart of an encoder of video/image compression using multiple coding modes with multiple color spaces, where weighted distortion is used according to an embodiment of the present invention. According to this method, the system receives input pixels of a current block in a current picture in step 510, where the current picture is divided into multiple blocks. For each candidate coding mode in a coding mode group, weighted distortion for the current block coded with said each candidate coding mode is calculated in step 520. The coding mode group comprises at least a first coding mode and a second coding mode, where the first coding mode uses a first color space for encoding one block and the second coding mode uses a second color space for encoding one block, and the first color space is different from the second color space. The weighted distortion corresponds to a weighted sum of distortions of color channels for each color transformed current block using a set of weighting factors and the set of weighting factors is derived based on a color transform associated with a corresponding color space for each coding mode. A target coding mode is selected from the coding mode group based on cost measures associated with candidate coding modes of the coding mode group in step 530, where each cost measure includes the weighted distortion for the current block using each candidate coding mode. The current block is encoded using the target coding mode in step 540. The target coding mode may correspond to a mode that achieves the least cost measure.

The flowchart shown above is intended to illustrate examples of video coding incorporating an embodiment of the present invention. A person skilled in the art may modify each step, re-arranges the steps, split a step, or combine the steps to practice the present invention without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

What is claimed is:

1. A method of video or image encoding using multiple coding modes with multiple color spaces, the method comprising:
receiving input pixels of a current block in a current picture, wherein the current picture is divided into multiple blocks;
for each candidate coding mode in a coding mode group comprising at least a first coding mode and a second coding mode, wherein the first coding mode uses a first color space for encoding one block and the second coding mode uses a second color space for encoding one block, and the first color space is different from the second color space:
calculating weighted distortion for the current block coded with said each candidate coding mode, wherein the weighted distortion corresponds to a weighted sum of distortions of color channels for each color transformed current block using a set of weighting factors and the set of weighting factors is derived based on a color transform associated with a corresponding color space for each coding mode;
selecting a target coding mode from the coding mode group based on cost measures associated with candidate coding modes of the coding mode group, wherein each cost measure includes the weighted distortion for the current block using each candidate coding mode; and
encoding the current block using the target coding mode.

2. The method of claim 1, wherein if one of the first color space and the second color space corresponds to YCoCg color space, the distortions of color channels are designated as Distortion_{Y}, Distortion_{Co}, and Distortion_{Cg} for Y, Co and Cg channels respectively, and the set of weighting factors are designated as W_{Y}, W_{Co}, and W_{Cg}, then the weighted sum of distortions of color channels is derived according to:
Distortion_{YCoCg}=Distortion_{Y}×W_{Y}+Distortion_{Co}×W_{Co}+Distortion_{Cg}×W_{Cg},
and wherein W_{Y}, W_{Co}, and W_{Cg} are derived based on the color transform associated with the YCoCg color space.

3. The method of claim 2, wherein the input pixels are in RGB color space, color transform matrix from the RGB color space to the YCoCg color space and inverse color transform matrix from the YCoCg color space to the RGB color space correspond to:
$$[ \begin{matrix}1 / 4 & 1 / 2 & 1 / 4 \\ 1 & 0 & - 1 \\ - 1 / 2 & 1 & - 1 / 2\end{matrix} ] , and [ \begin{matrix}1 & 1 / 2 & - 1 / 2 \\ 1 & 0 & 1 / 2 \\ 1 & - 1 / 2 & - 1 / 2\end{matrix} ]$$
respectively, and wherein norm values of the inverse color transform matrix for the Y, Co and Cg channels are 3, 0.5 and 0.75 respectively.

4. The method of claim 1, wherein if one of the first color space and the second color space corresponds to RGB color space, the distortions of color channels are designated as Distortion_{R}, Distortion_{G}, and Distortion_{B} for R, G and B channels respectively, and the set of weighting factors are designated as W_{R}, W_{G}, and W_{B}, then the weighted sum of distortions of color channels is derived according to:
Distortion_{RGB}=Distortion_{R}×W_{R}+Distortion_{G}×W_{G}+Distortion_{B}×W_{B},
and wherein W_{R}, W_{G}, and W_{B}, are derived based on the color transform associated with the RGB color space.

5. The method of claim 1, wherein color channels of color transformed input pixels in a corresponding color space are quantized using different quantization bit-depths and the set of weighting factors are further related to the different quantization bit-depths.

6. The method of claim 5, wherein one of the first color space and the second color space corresponds to YCoCg color space, the distortions of color channels are designated as Distortion_{Y}, Distortion_{Co}, and Distortion_{Cg} for Y, Co and Cg channels respectively, the set of weighting factors are designated as W_{Y}, W_{Co}, and W_{Cg}, and the weighted sum of distortions of color channels is derived according to:
Distortion_{YCoCg}=Distortion_{Y}×W_{Y}+Distortion_{Co}×W_{Co}+Distortion_{Cg}×W_{Cg},
and wherein W_{Y}, W_{Co}, and W_{Cg} are derived based on the color transform associated with the YCoCg color space.

7. The method of claim 6, wherein the quantization bit-depth for Co and Cg color channels is one bit less than Y color channel.

8. The method of claim 7, wherein the input pixels are in RGB color space, a color transform matrix from the RGB color space to the YCoCg color space including an effect of different quantization bit-depth and an inverse color transform matrix from the YCoCg color space to the RGB color space including the effect of different quantization bit-depth correspond to:
$$[ \begin{matrix}1 / 4 & 1 / 2 & 1 / 4 \\ 1 / 2 & 0 & - 1 / 2 \\ - 1 / 4 & 1 / 2 & - 1 / 4\end{matrix} ] , and [ \begin{matrix}1 & 1 & - 1 \\ 1 & 0 & 1 \\ 1 & - 1 & - 1\end{matrix} ]$$
respectively, and wherein norm values of the inverse color transform matrix for the Y, Co and Cg channels are 3, 2 and 3 respectively.

9. An apparatus for video or image encoding using multiple coding modes with multiple color spaces, the apparatus comprising one or more electronic circuits or processors arranged to:
receive input pixels of a current block in a current picture, wherein the current picture is divided into multiple blocks;
for each candidate coding mode in a coding mode group comprising at least a first coding mode and a second coding mode, wherein the first coding mode uses a first color space for encoding one block and the second coding mode uses a second color space for encoding one block, and the first color space is different from the second color space:
calculate weighted distortion for the current block coded with said each candidate coding mode, wherein the weighted distortion corresponds to a weighted sum of distortions of color channels for each color transformed current block using a set of weighting factors and the set of weighting factors is derived based on a color transform associated with a corresponding color space for each coding mode;
selecting a target coding mode from the coding mode group based on cost measures associated with candidate coding modes of the coding mode group, wherein each cost measure includes the weighted distortion for the current block using each candidate coding mode; and
encode the current block using the target coding mode.

10. A method of video or image encoding using multiple coding modes with multiple color spaces, the method comprising:
receiving input pixels of a current block in a current picture, wherein the current picture is divided into multiple blocks;
for each candidate coding mode in a coding mode group comprising at least a first coding mode and a second coding mode, wherein the first coding mode uses a first color space for encoding one block and the second coding mode uses a second color space for encoding one block, and the first color space is different from the second color space:
calculating distortions of color channels for the current block coded with said each candidate coding mode, wherein the color channels for the current block are generated by applying a color transform to the input pixels to convert the input pixels to a corresponding color space of said each candidate coding mode, and
deriving color transformed distortions for the current block coded with each candidate coding mode by applying an inverse color transform corresponding to the color transform to the distortions of color channels for the current block coded with said each candidate coding mode;
selecting a target coding mode from the coding mode group based on cost measures associated with candidate coding modes of the coding mode group, wherein each cost measure includes the color transformed distortions for the current block using said each candidate coding mode; and
encoding the current block using the target coding mode.

11. The method of claim 10, wherein the color channels for the current block are quantized using different quantization bit-depths and effects of the different quantization bit-depths are combined into the color transform.

12. The method of claim 11, wherein if one of the first color space and the second color space used by one candidate coding mode corresponds to YCoCg color space, the distortions of color channels are designated as Distortion_{Y}, Distortion_{Co}, and Distortion_{Cg} for Y, Co and Cg channels respectively, the Y, Co and Cg channels are quantized with quantization bit-depth for Co and Cg color channels being one bit less than Y color channel, the input pixels are in RGB color space, the color transformed distortions are designated as Distortion_{R}, Distortion_{G}, and Distortion_{B} for R, G and B channels respectively, then the color transformed distortions are derived according to:
$$[ \begin{matrix}{Distortion}_{R} \\ {Distortion}_{G} \\ {Distortion}_{B}\end{matrix} ] = [ \begin{matrix}1 & 1 & - 1 \\ 1 & 0 & 1 \\ 1 & - 1 & - 1\end{matrix} ] [ \begin{matrix}{Distortion}_{Y} \\ {Distortion}_{Co} \\ {Distortion}_{Cg}\end{matrix} ]$$

13. An apparatus for video or image encoding using multiple coding modes with multiple color spaces, the apparatus comprising one or more electronic circuits or processors arranged to:
receive input pixels of a current block in a current picture, wherein the current picture is divided into multiple blocks;
for each candidate coding mode in a coding mode group comprising at least a first coding mode and a second coding mode, wherein the first coding mode uses a first color space for encoding one block and the second coding mode uses a second color space for encoding one block, and the first color space is different from the second color space:
calculate distortions of color channels for the current block coded with said each candidate coding mode, wherein the color channels for the current block are generated by applying a color transform to the input pixels to convert the input pixels to a corresponding color space of said each candidate coding mode, and
derive color transformed distortions for the current block coded with each candidate coding mode by applying an inverse color transform corresponding to the color transform to the distortions of color channels for the current block coded with said each candidate coding mode;
select a target coding mode from the coding mode group based on cost measures associated with candidate coding modes of the coding mode group, wherein each cost measure includes the color transformed distortions for the current block using said each candidate coding mode; and
encode the current block using the target coding mode.

14. A method of video or image encoding using multiple coding modes with multiple color spaces, the method comprising:
receiving input pixels of a current block in a current picture, wherein the current picture is divided into multiple blocks;
for each candidate coding mode in a coding mode group comprising at least a first coding mode and a second coding mode, wherein the first coding mode uses a first color space for encoding one block and the second coding mode uses a second color space for encoding one block, and the first color space is different from the second color space:
applying encoding process to the current block according to said each candidate coding mode to derive source data and processed data, wherein the encoding process comprises one or more processing stages;
applying a common color space transform to the source data at a selected processing stage, wherein the common color space transform converts pixel data in a corresponding color space associated with said each candidate coding mode to a common color space;
applying the common color space transform to the processed data at the selected processing stage;
calculating unified distortion between the source data and the processed data after the common color space transform at the selected processing stage for the current block;
selecting a target coding mode from the coding mode group based on cost measures associated with candidate coding modes of the coding mode group, wherein each cost measure includes the unified distortion for the current block using each candidate coding mode; and
encoding the current block using the target coding mode.

15. The method of claim 14, wherein the encoding process comprises a prediction stage, followed by a quantization stage, followed by an inverse quantization stage, and followed by a reconstruction stage.

16. The method of claim 15, wherein the source data corresponds to input data to the quantization stage and the processed data corresponds to output data from the inverse quantization stage.

17. The method of claim 15, wherein the source data corresponds to input data to the prediction stage and the processed data corresponds to output data from the reconstruction stage.

18. The method of claim 15, wherein the encoding process comprises a transform stage and an inverse transform stage, wherein the transform stage is located between the prediction stage and the quantization stage, and the inverse transform stage is located between the inverse quantization stage and the reconstruction stage.

19. The method of claim 18, wherein the source data corresponds to input data to the transform stage and the processed data corresponds to output data from the inverse transform stage.

20. The method of claim 14, wherein if one of the first color space and the second color space used by one candidate coding mode corresponds to YCoCg color space and the common color space corresponds to RGB color space, then the unified distortion is measured by applying YCoCg-to-RGB color transform to the source data and the processed data.

21. An apparatus for video or image encoding using multiple coding modes with multiple color spaces, the apparatus comprising one or more electronic circuits or processors arranged to:
receive input pixels of a current block in a current picture, wherein the current picture is divided into multiple blocks;
for each candidate coding mode in a coding mode group comprising at least a first coding mode and a second coding mode, wherein the first coding mode uses a first color space for encoding one block and the second coding mode uses a second color space for encoding one block, and the first color space is different from the second color space:
apply encoding process to the current block according to said each candidate coding mode to generate source data and processed data, wherein the encoding process comprises one or more processing stages;
apply a common color space transform to the source data at a selected processing stage, wherein the common color space transform converts pixel data in a corresponding color space associated with said each candidate coding mode to a common color space;
applying the common color space transform to the processed data at the selected processing stage;
calculate unified distortion between the source data and the processed data after the common color space transform at the selected processing stage for the current block;
selecting a target coding mode from the coding mode group based on cost measures associated with candidate coding modes of the coding mode group, wherein each cost measure includes the unified distortion for the current block using each candidate coding mode; and
encode the current block using the target coding mode.
